(19) United States
(12) Patent Application Publication
(10) Pub. No.: US 2009/0150387 A1
(43) Pub. Date: Jun. 11, 2009

(54) GUIDED RESEARCH TOOL

(76) Inventor: Jodi L. Marchewitz, Pepper Pike, OH (US)

Correspondence Address: D.A. STAUFFER PATENT SERVICES LLC, 1006 MONTFORD ROAD, CLEVLAND HTS., OH, 44121-2016, US

(21) Appl. No.: 12/268,443

(22) Filed: Nov. 10, 2008

Related U.S. Application Data
(60) Provisional application No. 60/986,591, filed on Nov. 8, 2007.

(51) Int. Cl. G06F 17/30

(52) U.S. Cl. 707/5; 707/E17.108

(57) ABSTRACT

A guided research tool and related method of researching for resources related to a predetermined research topic. The invention provides the benefits of an always available, automated research librarian combined with an expert in the research topic, wherein the tool will interactively provide expert assistance and advice regarding selection of an internet search string that is optimized to conduct a real time search of the latest available resources on the internet, and then to provide a limited number of search result links to current resources that are most relevant to the research topic, or to an important subtopic thereof.

### CROSS-REFERENCE TO RELATED APPLICATIONS

This application claims the benefit of U.S. Provisional Patent Application No. 60/986,591, filed Nov. 8, 2007 by Jodi L. Marchewitz, and incorporated herein in its entirety by reference.

### TECHNICAL FIELD OF THE INVENTION

The present invention relates to method and apparatus for computer aided research.

### BACKGROUND OF THE INVENTION

Research involving a search for the best, most relevant information from available documentation (resources) regarding a particular topic has always been difficult, whether the topic is an obscure piece of arcane science, or “common knowledge” still unknown to the researcher. Alternatively, the “topic” of research may be the location/identity of a qualified provider (e.g., vendor) of a product or service. Or the topic may be how to find the “most qualified” provider of something, where qualification is judged by quality, cost, availability, and so on. Research may involve finding a book or magazine or other publication in a repository of such things, e.g., a library. The research could also involve asking “experts”, however then a qualified expert must be searched for!

The internet age has been, and continues to be, greatly expanding the type, quantity, and availability of resources. This makes it even more important to have expert assistance to focus the research on a limited number of quality results.

Research librarians are trained in such research and can provide expert assistance, especially if you know what to search for—in other words, the searcher may know the topic (e.g., brain cancer), and even a subtopic (e.g., surgical procedures for removing brain tumors), but a search for all references regarding the topic and subtopic is too broad, even if a generalist research librarian helps in the search. A reference librarian in a medical library would help more because she is more of an expert in medical topics and knows some of the best places to look (e.g., a university library that has been doing related research). But she won't necessarily know about a particular subtopic that will be particularly fruitful with most relevant resources (e.g., dog brain research in Poland). The researcher can ask medical experts for help regarding the choice of subtopics, but again the right expert must be found.

For most people, then, internet searching is often tedious, challenging and time consuming. Many try to use a search engine by simply typing a few words into the query box and then scrolling through whatever comes up. Most often the search results are a haystack of off-target web pages that must be combed through. There are three main reasons for this difficulty:

1. Sometimes people do not know exactly what they need and there is no good way for them to figure it out without a lot of searching. A quick search is only successful if you know exactly what you are looking for and you are experienced in filtering out the mismatched search returns. Search engines return results and then abandon the user. There are no criteria with which to make a decision on what is the best choice for the user.
2. Using the advanced search feature is difficult and most people do not know how to use it, or else don't know how to make effective use of it. As a result, people get so many unusable, mismatched results that they have to redo searches, guessing at different or additional words or phrases to search, and then clicking on links to see if the site meets their need. The ‘related terms’ help that some search engines provide assumes that users understand what the suggested words mean and what results they will yield. However, the suggested words don't always yield the most useful or relevant search results because rather than being picked by an expert in the field being searched, the software is simply presenting words similar to the ones the user guessed at, and the user may not have guessed anywhere near the right keywords.
3. Most users don't know how to find local resources, so their search results do not reliably tap into the many local resources available. Even if users include their geographic area in a search string, they still get mismatched results and don't find resources that are ‘optimized’.

Thus even if a researcher is good at searching they still spend significant time assembling a variety of keywords into search strings submitted to one or more search engines (e.g., Google, Yahoo), sifting through the resulting mostly irrelevant sites and data, refining the search string, and gathering the information found for later use. Or, like most people, one would have to ask someone who knows how to do it (or hire them), or waste immense amounts of time looking at many more sites than necessary. Microsoft found that people search an average of 11 minutes before they find what they are looking for or give up. Most people thus give up, or try a new search term, as evidenced by the small fraction of the people who click past the 5^{th} page of search results.

Some automated search assistants are available, such as an E-assistant (e.g., in a web store) that only searches within a topically limited database. With a focused database of limited size, it is feasible to pre-determine a set of questions to ask that will lead to predetermined answers—either a group of answers or individual answers. When searching for a toy in a toy store one can narrow down to the correct store location pretty quickly with only a few questions, because so much is already known about the customer's needs ahead of time. E.g., they are looking for a children's toy, because that is what this store sells and they came here.

Directory searches are another approach, exemplified by the DMOZ Open Directory Project, wherein a categorized list of resources is compiled, and then the categories are arranged into a decision tree. The categorization and addition of resources to their database is a Wiki-style collaborative effort. So only a particular, closed end, database of resources is searched, and the correct category and subcategory and sub-subcategory, etc. must be guessed to navigate the directory to get to the desired resources. For example, to find the abovementioned subtopic of brain cancer surgical procedures, one would have to select the medical topic from the top directory listing, then select the surgery subtopic from the medical directory listing, and then . . . but wait! Would I be better off picking diseases, then cancer, then brain subtopics? The difficulties are obvious. As in a Google search, expert advice on term selection would be very helpful. Also, the closed database is both good and bad. The resources in the database have been selected by “experts” and refined by collaboration, but the database will be slow to catch up with the ever-changing resources available on the internet, which is consequently an open-ended database.

Another approach to searching for information on a particular topic, especially if looking for an answer to a question, is to use an expert system. An expert system is a type of “artificial intelligence” (AI) that works from a closed database of expert knowledge (a knowledgebase). It is being used in automated decision support systems, and is most effective when applied to a focused domain of knowledge, for example as an automated medical diagnosis aid. Earlier forms of expert systems had a set of answers linked to questions in a decision tree, but both the questions and the answers had to be pre-determined by experts (humans!) and entered into the knowledgebase. Now AI programs using “fuzzy logic” can interact with users in a simulated question and answer dialog wherein the questions can be adapted by the computer (program) according to the answers being given. A disadvantage is that the knowledgebase must be constantly updated and expanded as the experts learn more answers, and/or learn more questions that may be asked, and consequently the decision tree must also be updated to maintain suitable links between questions and answers. In particular, as with a directory search, the major shortcoming is that the knowledge database is limited to what is entered in it. Thus the expert system can only search for predetermined answers that have already been entered in a closed end database.

Thus, it is an object of the present invention to remedy the deficiencies of the prior art by providing the benefits of a research librarian who is always available (via the internet), combined with a likewise-available team of experts (like an expert system) who will interactively provide assistance and advice regarding an internet search for resources best related to a research topic.

### BRIEF SUMMARY OF THE INVENTION

The present invention concerns a “Smart Search Assistant” (SSA) or “Automated Mentor” that can be said to provide a “People Powered, Technology Enabled Search”. The invention also includes various computer algorithms, processes, and business methods related to implementation of the SSA. The invention is a virtually intelligent computerized “assistant” or “mentor” that guides people through complex internet-based searching and decision-making, ultimately connecting them to a reasonably short, focused list of useful and/or most relevant information or resources (including vendors and service providers, optionally local, as is appropriate). An important aspect of the SSA is a set of “decision trees” which are custom made initially by expert searchers. A decision tree will be appropriate for use in a particular type of search, but may be generic to a wide variety of technologies, areas of endeavor, object types, etc. Users can select from pre-existing search categories/subcategories and/or type in key words, and then the Smart Search Assistant (SSA) will step the user through a decision tree that guides them until they identify exactly what they need. Once the user has gone through the decision tree, a customized search string is formed by the SSA and sent out to one or more search engines such as Google™, Yahoo™, MSN™, to get the results needed by the user. The search string is developed with filters (e.g., Boolean operators with selected keywords) based on answers the user provided during the decision tree session. Thus, the SSA will return the most useful/relevant search results. Not only is the search string customized, but also it may be directed to a particular search engine and/or search database that the SSA determines to be most appropriate in accordance with the user's responses to the decision tree questions. Thus, a preferred embodiment of the invention is a system using decision trees with the terminal node ending in a keyword search using a network of connected computers. Other inventive methods, systems, and devices may become apparent from the description hereinbelow, all of which are asserted to be within the scope of one or more inventions of the present inventor.

Therefore, according to the invention a guided research tool for assisting a user's research on a topic is disclosed, the research comprising a search for resources related to the topic, the searched-for resources being documented knowledge and/or entities qualified to provide knowledge, goods and/or services; the tool comprising: a guider being one or more computer software modules, for use with a computer having an input/output interface enabling interaction between the user and software running in the computer, the guider comprising: a knowledgebase provided by an expert on the topic, and comprising an optionally nested set of selected subtopics of the topic, arranged in a decision tree of nodes connected by path portions with questions at branching nodes for output to the user wherein the user's input answer selects a path portion to another node; an expert advice item at a node, wherein the item advises the user with information intended to assist the user in answering a question or in selecting an option when the user is at the node; and a searching node wherein a search string, constructed according to the path that the user selected to reach the searching node, is submitted to a search engine, and links to resources returned by the search engine are output to the user, thereby researching the topic by performing a new search and outputting a new listing of resources that are expertly focused on the topic.

Further according to the invention, any combination of one or more of the following aspects or elements may be added to the inventive guided research tool:

a system combining the tool with a computer having a user interface enabling input/output interaction between the software and the user.

the original expert and optionally additional experts provide definitions, and helpers: explanations about what each subtopic is, and why it is important

the guider (preferably on internet site) presents a “selection screen” (node) listing sub-topics to be searched, and makes definitions and helpers easily available, so that user can pick a subtopic best meeting their need

subtopic selection either leads to another selection screen, or to a search results screen that presents a limited list of results of an optimized, focused search, the results having links to the resources. Optimized search string predetermined by expert(s)

2. sponsored links on selection screen
3. Google adsense (“Sponsored Links”)
4. Guider selection can branch to another guider for subtopics
5. Portable guiders
6. search for information, service vendor, product vendor
7. provide lead qualification details to vendor
8. create guider database of vendors local to a particular geographic area
9. helper (expert advice item) can be any mime type
10. analytics
11. solicit feedback, rate the subtopics/selections, the advice, the 3^{rd} party objects and the search results
12. add chat option on node page
13. link to appropriate support forum
14. user registers so can save search, path to go back later

Other objects, features and advantages of the invention will become apparent in light of the following description thereof.

### BRIEF DESCRIPTION OF THE DRAWINGS

Reference will be made in detail to preferred embodiments of the invention, examples of which are illustrated in the accompanying drawing figures. The figures are intended to be illustrative, not limiting. Although the invention is generally described in the context of these preferred embodiments, it should be understood that it is not intended to limit the spirit and scope of the invention to these particular embodiments.

Certain elements in selected ones of the drawings may be illustrated not-to-scale, for illustrative clarity. The cross-sectional views, if any, presented herein may be in the form of “slices”, or “near-sighted” cross-sectional views, omitting certain background lines which would otherwise be visible in a true cross-sectional view, for illustrative clarity.

Elements of the figures can be numbered such that similar (including identical) elements may be referred to with similar numbers in a single drawing. For example, each of a plurality of elements collectively referred to as 199 may be referred to individually as 199a, 199b, 199c, etc. Or, related but modified elements may have the same number but are distinguished by primes. For example, 109, 109′, and 109″ are three different elements which are similar or related in some way, but have significant modifications. Such relationships, if any, between similar elements in the same or different figures will become apparent throughout the specification, including, if applicable, in the claims and abstract.

The structure, operation, and advantages of the present preferred embodiment of the invention will become further apparent upon consideration of the following description taken in conjunction with the accompanying drawings, wherein:

FIG. 1 is, according to the invention.

FIG. 2 . . . etc.>

### DETAILED DESCRIPTION OF THE INVENTION

In the present disclosure text has been incorporated from the provisional application and potentially other documents wherein embodiments of the invention are variously titled a Guided Research Tool, a Guider, a Mentor, a Smart Search Assistant (SSA), and/or a Module thereof (e.g., an SSAM which is an SSA implemented for a specific topic or domain of resources). All such titles refer to embodiments within the scope of the invention, as will be apparent from the context within which the names are used.

The invention will be described in several overlapping forms which include both method (e.g., computer software algorithms or procedures) and apparatus (e.g., computer hardware that implements the method). Thus, for example, the term “guided research tool” should be understood to refer to either or both method and apparatus that embody the invention.

Finally, various trade or service mark names are used herein, sometimes with acknowledgement indicated by appending, for example, a raised TM label. Any omissions of such acknowledgement labels are inadvertent and should not be interpreted otherwise. For example, “Google” is recognized herein as a trademarked name, even if not marked accordingly.

The present invention, which may be called a “Guider” for reasons that will become clear, is a search overlay tool that will help a user find an optimum “search string” of keywords for an internet search. It enables the user to execute the search right from within the Guider (i.e., while the computer actions, input and output are being controlled overall by the Guider software). The Guider directs a user to topical decision making information and tactical how-to information (resources) available on the Internet. Guiders can also present product and service provider solutions that correspond to the user's needs, thereby helping to streamline the search process (a.k.a. “research”).

For example, if someone uses a search engine without a Guider to research the topic of public relations (PR), they'll get over 4 million unstructured search results in response to the search string “public relations”. With a Guider, a user gets to choose from a breadth of PR sub-topics to explore. For example, the Guider can produce search results that link to resources detailing examples of PR, or information on why they would use a certain PR tool over another. For example, the Guider will advise (and perform) a search on the steps needed to use a specific type of PR the right way. People “don't know what they don't know” which is why many searches aren't productive. With a Guider, a user always ‘knows’ what they need to know to execute the best search for optimum results.

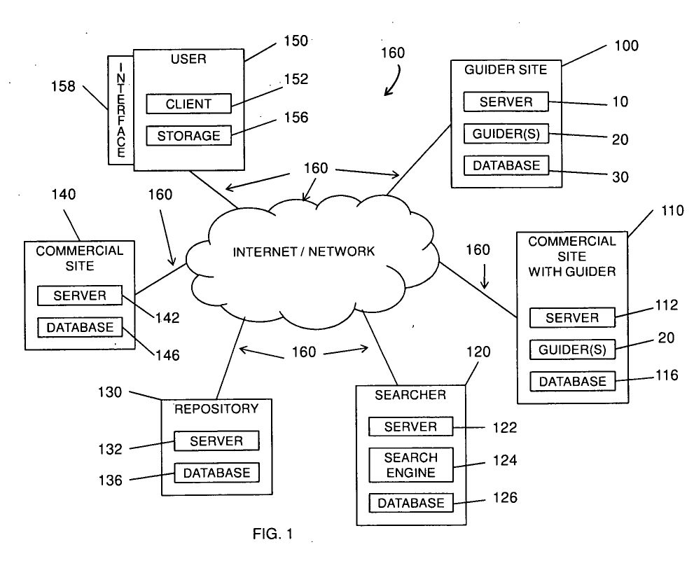

Referring now to the drawings, FIG. 1 shows the structure 160 within which the invention operates. Among other things, the “internet” (global network) 160 includes communication/networking lines 160 that link a user's computer 150 to commercial “websites” 110, 130, 140, “searcher”/“search engine” websites 120 (e.g., Google™), and resource repository websites 130, all of which maintain their web access with server software/hardware, and have computerized “databases” 116, 126, 136, 146 containing resources that may be accessed over the internet 160 by, for example, “links” appearing in search results from search engines 124. The term website is used in a generic way to refer to the hardware such as computer(s) and server(s), plus the internet interface software running thereupon, plus the web “pages” that provide the interface, all at a particular URL or domain of URLs.

The present application discloses a novel “Guider Website” 100 that has one or more Guiders 20 implemented as software modules running under its control. The inventive Guider 20 is interfaced through the server 10 to enable a user at the user's computer 150 to operate the Guider 20, interacting with it via the user's interface hardware 158 (e.g., monitor, keyboard, mouse, etc.) and his client software 152 (e.g., browser) and to cause the Guider 20 to perform a search of the internet database 126 at the searcher website 120 using the searcher's search engine 124.

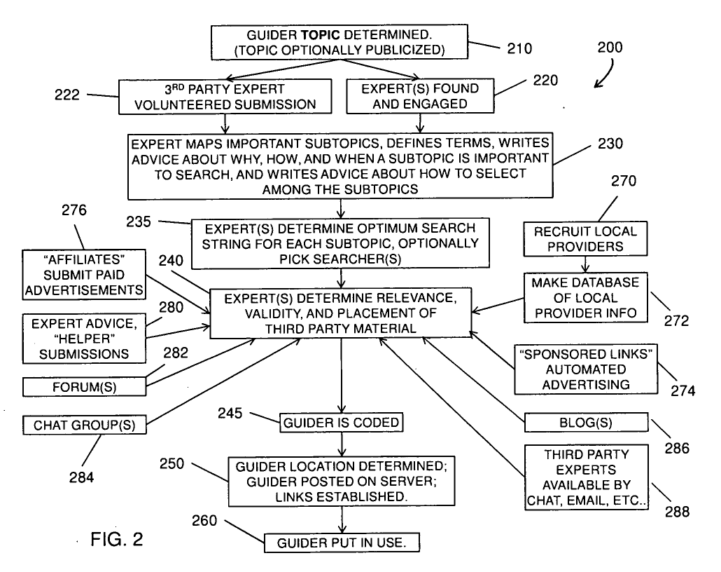

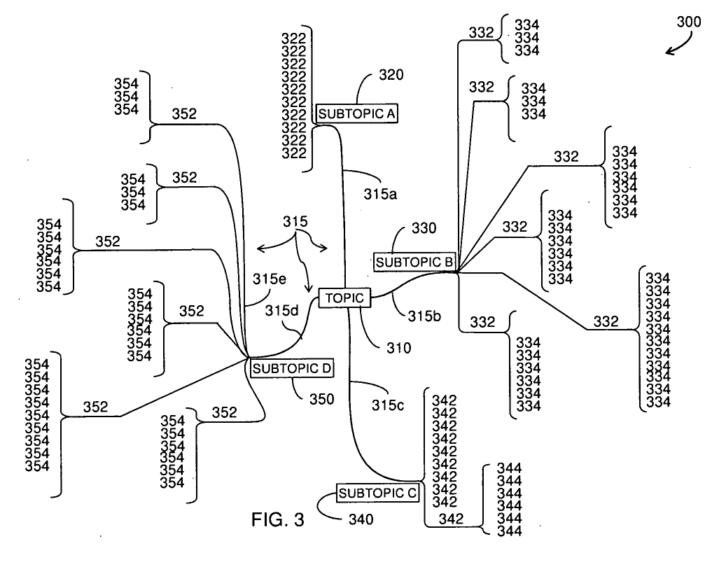

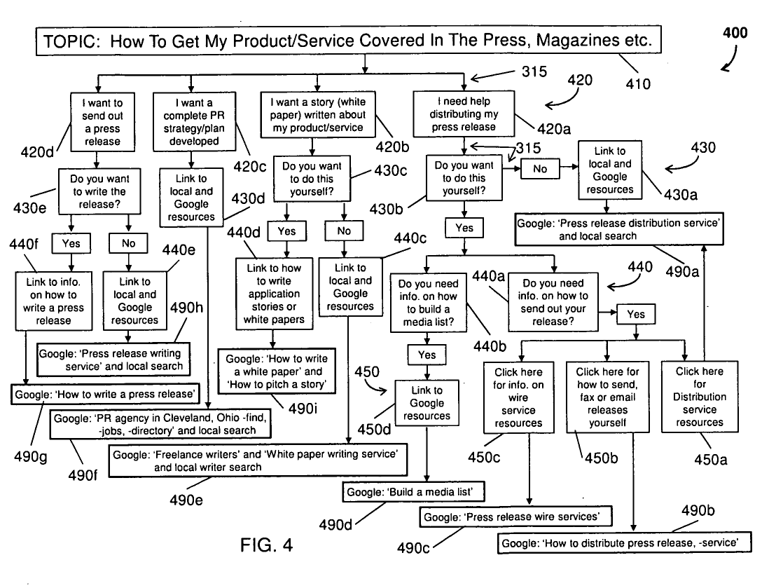

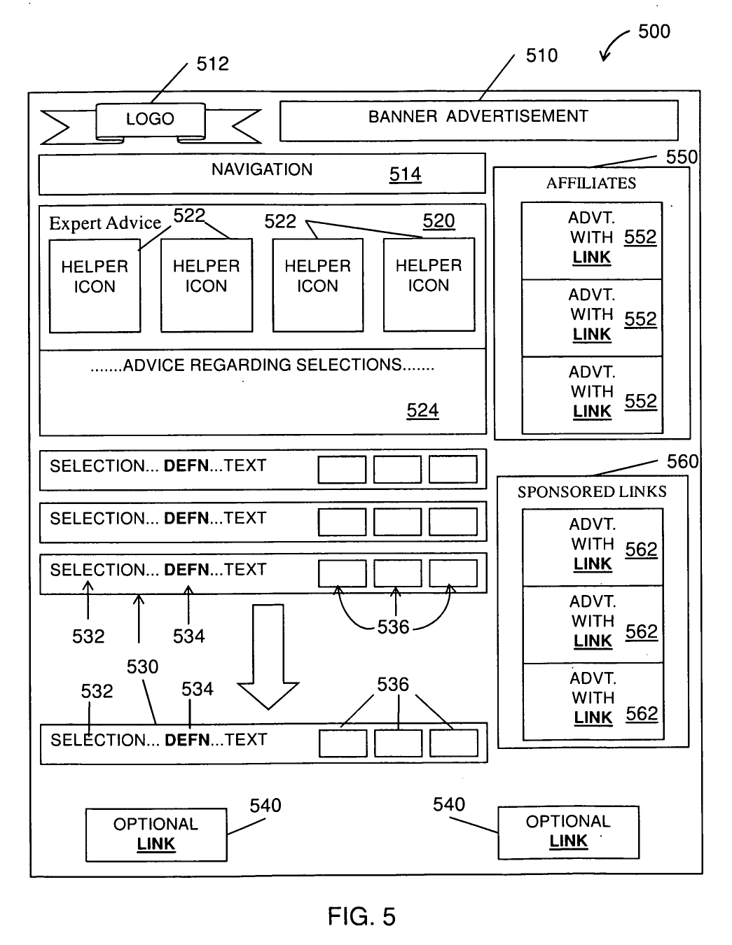

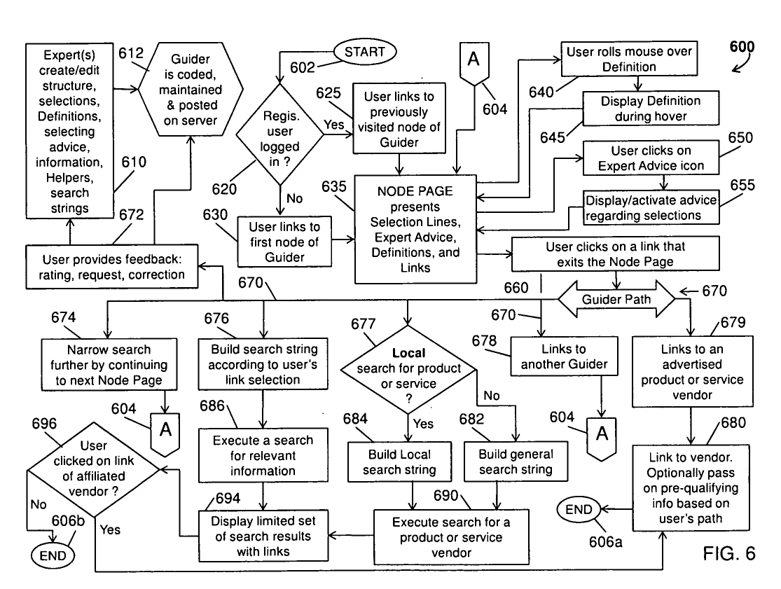

FIG. 2 shows an overview of an inventive method 200 for implementing a particular Guider module 20, i.e., a Guided Research Tool focused on a specific “topic” or domain of resources and the information that they contain. First 210 a topic is selected, for example the corporate entity owning the Guider IP, the “Guider Co” may see a large public need for guided research on topic-A, so they decide to create a new Guider 20 for topic-A. They find an expert on topic-A 220 and engage him in the effort 230. The expert may be self-identified by a third party 222. Using any convenient method or software tool, such as “mind mapping” software, the expert maps (identifies and organizes) all the sub-topics that he feels are most important to deal with when researching topicA, and also documents all the related advice and information that will assist, or guide, a researcher in their determination of which of the subtopics they need to learn more about. Finally, the original expert and/or other experts determine 235 the most optimum search string to use for a database (e.g., internet) search on each of the subtopics. They can also select a particular search engine (searcher) to recommend using for a search.

Next, 240 experts can select from a variety of outside material (as illustrated) to place the most helpful information on each node page, and then the guider module is coded 245 posted and linked as needed 250 and made operative and available for public use 260, for example on the Guider Co. website 100. A node in the Guider 20 may link out to a helpful node page in a different but related Guider module 20 that could be on another entity's website 110.

While the Guider 20 is in use, portions of the development process 200 can be iterated to maintain, correct, and/or improve the usefulness or functionality of the Guider 20. In particular, “helpers” can be created by third parties and submitted 280 for use as “expert advice” items (e.g., mime objects 522 shown in FIG. 5). The submissions can be managed as a collaborative effort, Wiki-style, with ratings and votes and modifications being submitted. The company's internal expert doesn't control submissions, the 3rd party who wants to say upload a video to the expert advice section decides to place the video in relevant Guiders—user feedback and internal monitoring at iGuiders helps determine if there is “expert material” in the wrong places. The “experts” can be other people than the original expert. These experts are the ones doing the internal monitoring and making the decisions about acceptance/rejection and placement of any 3rd party submissions. There could be a branded version of the Guiders. People may create their own guiders that will work with the company's, but cannot call them a branded Guider module without the company certifying it (and giving/selling them a license to use it, at least while a patent is in force). This gives quality control as well as patent protection. Regarding the helper modules (e.g., “expert advice” mime content), we will want to clearly indicate what content is outside-provided and rated versus material (e.g., “what is”) that is totally under your control and therefor approved (and you should say that it is copyrighted also).

FIG. 5 shows an example of a node page that presents several selection lines 530, wherein the selection text 532 may ask the user a question that can be “answered” for example by clicking on an appropriately labeled selection button 536 (one or more may be present on a line, but typically only one that is a link to advance to another node page 500 in the Guider structure. The button 536 could also be a checkbox or even a dialog box allowing a typed response. The button 536 can also be a link to a search node (e.g., a node 500 that implements steps 676 plus 686 plus 694 in FIG. 6). Furthermore, there can be two buttons 536 on a line that are labeled to indicate selection of a particular search engine to be used in the search triggered by clicking on the button (e.g., a Google button, and a Yahoo button). If the user desires expert guidance in order to pick a selection button 536, then several expert help sources may be made available, including a definition 534 that pops up when the mouse rolls over a highlighted word 534; a paragraph of advice in the expert advice panel 520 that may always be displayed or may roll down when a trigger icon 524 is clicked (e.g., a stylized question mark). One or more helper icons 522 may be present. These are mime objects that can be activated via the mouse, e.g., a white paper, a video. Other links 540 may go to a related blog, chat group, or forum, for example. Advertisements 550, 560 can also be presented, the affiliate ads being solicited for a special database of, for example local providers (steps 270, 272).

FIG. 3 shows an example of a topic “map” created by an expert in step 230. From the main topic 310 path portions 315 lead to nodes for subtopics 320, 330 etc. Each of those subtopics would be presented on the first node page 500 of a guider for the topic node 310. (step 635)

FIG. 4 shows an example of a guider 400.

FIG. 6 shows the method 600 implemented by a Guider module 20. It should be noted that the Guider 20 isn't searching an internal database, it is searching the entire internet using outside search engines. Of course a company can have a Guider on their website searching information paths on their site in their private database.

<prv< Wouldn't it be nice to have a friend/mentor who is available 24/7, who's an expert at searching, has the time to search, knows how to find the right searching criteria, filters out things that aren't relevant, “bottom-lines” the results you need, and identifies “local” resources for you if needed? Someone who asks you a few questions and then quickly determines an ideal search string that zeros right in to the results you need, all in a manageably short list of search hits! The present invention, a Smart Search Assistant (SSA) provides a better way.

People are becoming more astute and demanding better results, and they're demanding a more powerful search experience. The present invention, an SSA, is a computerized virtually intelligent (a.k.a. “artificial intelligence”, AI), search system that ‘walks’ a user through a series of search decisions so that they find exactly what they are looking for. The SSA can be part of a website, or a program running on a private computer or network of computers. The website can be a generally available URL owned and run by a single business owning the IP, by a franchisee, by a licensee, etc. The SSA can be made available by one or more search engine companies as an integrated option, or as a link. The SSA system/method/process/concept can be focused on a particular genre of resources and/or a specific type of decision-making, for example. Therefore, it can be advantageously customized for, and used by, special purpose websites, which could also be linked to a special purpose search engine and/or database.

Users can select from pre-existing search categories/subcategories and/or type in key words, and then the Smart Search Assistant (SSA) steps the user through a decision tree that guides them until they identify exactly what they need. Users can ‘hover’ over terms they do not understand and definitions (e.g., from Wikipedia) can be displayed. Once the user has gone through the decision tree, a customized search string is formed and sent out to one or more search engines such as Google™, Yahoo™, MSN™, to get the data. The search string is developed with filters (e.g., Boolean operators with selected keywords) based on answers the user provided during the decision tree session. Thus the SSA will return the most useful/relevant search results. Not only is the search string customized, but also it may be directed to a particular search engine and/or search database that the SSA determines to be most appropriate for the needed type of search. In addition:
Preferably the SSA output results will be a hybrid of search results from Google (for example), and local data submitted by local resources (things you can't find in regular Google searches, e.g., independent contractors, small companies, identified experts, and resources not having information on a public webpage or otherwise not normally accessible by the major public search engines). The SSA service will enable local service providers, independent contractors, companies, etc. to fill out a detailed profile of services so the SSA can tag the service provider as relevant when a user is looking for their specialty (unlike white pages and yellow pages that only identify resources based on broad categories).
The SSA remembers the data a user typed into the SSA for a search, and can use that data for future searches, or to repeat a search at a later date. All SSA-determined search strings and resulting hit lists will be saved to the user's account.
Users are invited to submit search strings from searches that they performed that aren't listed on the SSA site. In this way, the SSA service gains insight from the “wisdom of crowds” and builds loyalty to the site. (promote reusable searches—see below for details.)
A user's search results can be downloaded/exported to a spreadsheet, a word processor, etc. for simplicity and local management of information. In addition, search results and/or search strings can be emailed to other users, clients, etc. all at the discretion of the user.

### Scalability

Can a significant difference be made by manually selecting the best results for some searches? “It turns out that search query usage consistently follows a Zipf distribution. This means that if you have 50,000 unique search queries, a small number of them (perhaps 700) will be responsible for a large amount (maybe 45%) of your searches. Manually selecting best bets for those 700 search queries is achievable.”

### A Big Idea

According to Google, there are 1.3 Billion people using the Internet. Assuming the 80/20 rule, that 20% are great at searching, you have 80% of 1.3 billion people who could benefit from better search capabilities. For the average user who wastes tons of time searching, reading through irrelevant results and re-searching, they will embrace an evolution in search capabilities. As a result of the SSA, there will also be an evolution in the way people/companies list their information.

We are the NOW generation. We want the right information in real-time, and we want it to be exactly what we need when we need it. Use of the SSA for complex searches will save people and businesses a ton of time and money. The Smart Search Assistant is not in itself a search engine—rather it creates optimized search strings to submit to a search engine, and then it analyzes and displays the search results. The Internet needs more intelligence than current search tools provide.

Thus the SSA is a People Powered, Technology Enabled search mechanism. A key aspect of the SSA is a set of decision trees that are custom made initially by expert searchers. A decision tree will be appropriate for use in a particular type of search, but may be generic to a wide variety of technologies, areas of endeavor, object types, etc.

For example, a decision tree and resultant search strings are shown in FIG. 6. This example decision tree is generic to any type of product or service, but is specific (limited) to searching for “how-to” information/resources/etc. in the press coverage endeavor. This decision tree may be improved by adding questions or otherwise enabling user input of the type of product or service (e.g., a widget) being considered by the user, and then further tailoring the output search string to look in databases related to widgets, or to filter out search results not appropriate for use with widgets. This is an example of an improvement that can be made by the SSA service's “expert” in response to feedback from users, or could even be automatically “learned” by the SSA computer routine as a result of accumulated experience and/or automatically collected feedback from users. It should be noted that in the FIG. 6 example, the SSA output search strings are tailored to produce search results that link to different types of resources, i.e., in this case either a how-to document or a service provider, whichever the expert determines is most appropriate for the instant decision tree path. Of course, these are just two examples of the many types of resources that can be utilized.

The inventive SSA system (method, framework, etc.) can accommodate a wide variety of decision tree types. Other examples include, but are not limited to, one that guides a person in a search for a College/University to go to; and one that aids a user wanting to determine where to go to see a medical specialist who treats a particular disease (e.g., a rare form of cancer).

Examples of Searches that can Benefit from the SSA

The inventive SSA helps in searches that are more than a basic search—anything you need to think through, that needs a decision will benefit from the SSA. For example, if you already know you want to upgrade the windows in your house to Anderson Windows, then you know what you want, and you just have to search through their website or those of Anderson Windows vendors/distributors/installers/etc.

But, if you know you want to upgrade the windows in your house but you don't know what is available, or how to make a selection—aluminum, vinyl, wood, energy-efficient, casement etc.—then you need the SSA.

Just a few complex decisions that can benefit from SSA: Starting a business & all of the searches involved New product development Renovating a house Refinancing your home Finding games for your device Event planning Finding top hospitals or doctors of a certain specialty Refinancing your home Business

Models for Use of the SSA: Participating in or developing an ad program—like Google's PPC, AdWords, AdSense etc. Productization: Companies can buy the functionality for their own sites Service—Information/Metadata Optimization to maximize SSA results; Partnering with another search engine or creating a new one (Google 53% of search market, or Yahoo 23% of search market, or MSN 11% of search market), or selecting search engines according to type of search.

Marketing Concepts for the SSA: Maximize social networking tile ads to atomize our information & distribute it in relevant places get people to contribute to searches by submitting successful searches or creating ones we don't have (reusable searches save time).

Opportunities: Maintain ownership of the SSA service as a business entity—support it with ads, Google adsense, or a Google adword type situation. Sell to Google, Yahoo, MSN, or another. Develop the SSA and have people buy or license the technology to use in other industries. Develop a separate company that optimizes the way companies list their services so that they dovetail with the SSA logic.

Ideas on What Else We Can Do With This Inventive Concept: There are two basic parts to my overall concept, potentially resulting in more than one inventive system, computerized method, or business method.

There is the Local Resource development aspect, which I believe should be separated from the Decision Tree/Smart Search Assistant aspect, i.e., the SSA. I still think I want to pursue putting together a free website that local companies and independent contractors can use to submit very detailed information about their services. We can have it all automated. Users would come to the site, pick the category of service they fall into and a form would come up asking them questions about their specialties so we can find out exactly what they offer. Then, when searches are executed in the SSA website, it'll get data from this local resource website as well as Google etc. Since we have control over what information the service providers submit, we'll be able to write search strings for the SSA Decision Tree that will find those resources. With this scenario, we are maximizing the fit and usefulness of the search results, and providing much needed local results.

Another aspect is the SSA (Decision Tree/Smart Search Assistant) website. Along with having this as a website with solutions, services and ads, we can have people submit Smart Search Assistant Modules (SSAM) that they have developed for use within our SSA framework. An SSAM is a customized software module for use in the SSA system to perform a particular smart search decision tree yielding optimized search strings. To make submissions to us, users can: a) come to our site and create an SSAM including the name of the task (or title), all the information to populate and create the decision tree, and the search strings that go along with it that are executed at all of the terminal nodes of the decision tree; or b) download an SSAM development program that they can use to create an SSAM as described in ‘a)’ above but to create it offline and then submit it to us online. The SSAM development program provides an interface that visually shows them the decision tree as they are creating it, for example in a flowchart format as shown in FIG. 6. When their SSAM is completed, they'll submit it to us for a quality and effectiveness check. If we accept it, then we will compensate them in some way as incentive for their doing the work. We still need to decide on the most effective but cost-efficient form of compensation. Potential compensation methods include: name recognition, a banner ad, a portion of the revenue from users of their SSAM, or we can follow a model like www.mahalo.com wherein we would pay a fixed amount to buy an acceptable submission.

Another thing we can do is let people use one or more of our smart searches (SSAMs), put them on their own website, and customize the terminal node search string to find the information on their own site. Then we would create a ‘card catalog’ of SSAMs that people could use. We can track this and get revenue whenever people use our SSAMs. Or, we could charge them for putting an SSAM on their page. Of course, to use the SSAM they would have to use our proprietary SSA system (patent pending as of the provisional application filing date). If we can patent the SSA process, we can make money by licensing its use. We could have people bid to have an ad for them placed on our website page when a smart search submitted by them is done on that page. We could maintain control by licensing/renting them a link on their website that would take the user to a webpage utilizing their SSAM in an SSA running on our own server. This would be transparent to the user since the searching webpage would be customized to look like a part of the renter's website.

As an example web service embodiment of the inventive guider/SSA/guided research tool described hereinabove, consider a “mybiz” website presented as: An Opportunity to Increase Business Success by Automating Mentorship and Matching Tasks to Service Providers

myBiz is a website for start-ups and growing businesses that provides a better way to find the exact information they want, and the best local resources to fit their needs. It consolidates information on the top 250 tasks that start-ups and emerging companies need to execute, and puts it in one easy to find place that is searchable and available 24/7. myBiz meets the needs of the ‘now’ generation where people want the right information in real-time.

It offers a process driven search capability in the form of an ‘Automated Mentor’ (i.e., the Smart Search Assistant, SSA). The Mentor (especially the decision tree portion of SSA) helps businesses identify what tasks need to be completed to meet a business objective, and identifies resources they need to execute those tasks. Once the resource needs are identified, the Mentor uses customized/optimized search strings to comb appropriate databases (e.g., internet, and/or a special purpose myBiz database) for necessary information and for local service providers/vendors of the needed resources.

Businesses that know what tasks they need help with can bypass the Mentor, and use the search engine to find service providers based on detailed business information (e.g., find providers specializing in print-on-demand and small print jobs, and rank those providers according to criteria such as local accessibility, convenience, price, etc.). myBiz takes the specific needs of the user and matches them with the specific offerings of service/product providers, especially local ones.

Start-up business owners are frustrated because they have a variety of tasks to complete, yet they do not know what type of help they need, whom to hire, or where to find service providers that meet their unique needs and budget constraints (print-on-demand, illustrator, web developer, PR person, etc).

Owners of growing businesses are frustrated because they know what they need, but they cannot find the right service providers without dedicating a lot of search time. There are many different sources available, but none of them gives the user the ability to execute a search based on detailed business needs, and then return ONLY relevant service providers that meet their specific needs. As a result, they often have to do more research to find the right providers, or they end up wasting time and money on bad decisions.

Having access to a comprehensive, process-based search resource like myBiz will provide start-ups and small businesses a place to go to ask implementation questions, and a tool to use that makes sense of the available business data. With this resource, users can get the answers they need to avoid costly roadblocks in the execution of their tasks.

When they access myBiz, the Automated Mentor tool helps users identify what tasks they need to complete by asking them a series of questions and taking them through pre-programmed decision trees until the user has the answer(s) they need (i.e. if a person wants to develop a product, the Mentor takes them through all of the steps in the process of product development and helps the user identify what step they are at, what they still need to do, and assesses where they need help).

Once the user identifies what task(s) they need assistance with, or for businesses that know what they need, the Mentor searches the myBiz service provider database (businesses, independent contractors, students, etc.) and locates specialists who meet the user's unique requirements, budget and location. The Mentor is available to users 24/7 and more quickly provides the right answers and the right resources needed, saving the users time and money.

How myBiz is Different from Current Products/Services on the Market: Emerging businesses need the right information and the right resources in real-time. myBiz is different because it takes the guesswork out of the search by leading the user through the process of what they are trying to achieve, and then leads them to the answers they need based on the information extracted during their session with the Automated Mentor. Searches for information and resources are optimized because they can be executed based on very detailed business information and only relevant local resources are returned.

When a user executes a search at places like google.com, or allbusiness.com, the search results inundate the user with irrelevant data. This forces the user into a time intensive process of digging through the plethora of information provided, or forces them to keep refining their search until they finally get the results they want. Also these search engines do not help the user identify the best, or the most relevant local solutions for their needs.

myBiz provides a better way for businesses to find the exact information they need, and the best local resources that fit that need, affordably and quickly.

myBiz has a large market because it targets all entrepreneurs, start-up companies, growing companies and service providers (companies, independent contractors, and students).

Service providers often rely on word-of-mouth advertising to bring in customers because they have a specialty that does not ‘fit’ into the regular categories set by resource finding sites. It is not worth it to them to pay money to list on their sites because there is no avenue to help people find them. myBiz provides a venue for them, as well as independent contractors and graduate students to match their expertise to companies that are looking for that specialty.

Just in Cleveland, there are over 30,000 target businesses. There is a tremendous opportunity to sign-up service providers, users and advertisers trying to reach the start-up and small business market.

Once the initial tasks and decision trees are formulated in the Automated Mentor, more information will continually be added to grow the database. After the pilot program is completed and the site is launched in Cleveland, myBiz will expand to markets beyond Cleveland. It is a very scalable service that will eventually have national coverage and a sizeable opportunity.

The Guided Research Tool and its various forms that may variously be named herein as a Mentor, a Guider, a Smart Search Assistant (SSA), and/or a module thereof (e.g., SSAM wherein the module is an SSA implemented for a specific topic or domain of resources), has been described in the following ways:
SSA walks a user through a decision tree with the terminal node ending in a keyword search using a network of connected computers.
SSA remembers what topics a user has searched on and saves their searches in a ‘my profile’ type folder.
Users can export ‘local’ contacts returned in their searches to Excel, Word, etc.
Users will have the option to save the information obtained during a person's search, so a) it remembers user's answers filled out in the decision tree—a user can change answers in the decision tree without having to go through the entire tree again, and b) it remembers previous answers so it can automatically put in the answers if the user is doing a similar search with the same questions for a different task.
SSA will work on Mobile Web.
Search results can be emailed to other people.
While using the SSA if people don't understand a word, they can either ‘hover’ over it and get a Wikipedia type definition, or a person can click on the word and a definition box will pop up.
Search strings bring back links to information, resources, photos, video etc.
All SSAMs will go through Quality Control to ensure they work properly and bring back the best searches.
Users may bypass the decision tree portion of the SSA and just use the Local Web portion of the site to find resources (e.g., using their own search strings)
   Participation from Users is Enabled in the Following Ways:
People can request a mentor (SSAM) on a topic.
People can submit their own SSAM decision tree for a task with included search strings, or they can submit them without the search strings.
People can put our SSA system, optionally with a limited set of SSAMs, on their website for either a fee or we get a percentage of ad dollars related to each search (to be determined).
People can use our SSA software for some type of fee (e.g., license), put it on their website and develop their own search strings or tweak ours, such that the SSAM finds information on their own site. For an extra fee we can supply selected SSAMs, possibly developed specifically for them (more fees).
People are invited to tell us which searches don't work well for them or need to be adjusted.
People can create the SSAMs online and get a visual representation of the decision tree they are creating.
People can download our SSAM development software, create an SSAM offline and also see a visual representation of the decision tree they are creating and then upload it online and submit it to us.
People will submit their zip code or city & state so the SSA can find local results.
   The SSA has Local Web Aspects such as:
Service Providers (Companies, freelance people, independent contractors etc.) are invited to submit information on their specialty to the site so the SSA can find them and return their name when users are looking for their specialty.
Users will fill out a profile form that asks for specific information about their specialties. Forms are tailored to match the category/subcategory of someone's profession or specialty.
Users can recommend a service provider to the site and we will contact that business or person they would like to invite to submit their information to the Local Web.
We may introduce a review system of service providers at some point, e.g., using the Angie's List™ model.
Focus on trying to get ‘word-of-mouth’ providers on this list so people can find them.
Local Web offers ability to inactivate your account but save the information if you want to reactivate it at a later date.
Each year on January 31^{st}, an email will be sent to all Providers listed to check the accuracy of their information and make sure they are still in business.
We could try to get Google to index providers on this Local Web.
Only those with an active email account may list.
Only those who fill out the form completely will be listed.
Submission will be automated.

Although the invention has been illustrated and described in detail in the drawings and foregoing description, the same is to be considered as illustrative and not restrictive in character—it being understood that only preferred embodiments have been shown and described, and that all changes and modifications that come within the spirit of the invention as claimed are desired to be protected. Undoubtedly, many other “variations” on the “themes” set forth hereinabove will occur to one having ordinary skill in the art to which the present invention most nearly pertains, and such variations are intended to be within the scope of the invention, as disclosed herein.

What is claimed is:

1. A guided research tool for assisting a user's research on a topic, the research comprising a search for resources related to the topic, the searched-for resources being documented knowledge and/or entities qualified to provide knowledge, goods and/or services; the tool comprising:
a guider being one or more computer software modules, for use with a computer having an input/output interface enabling interaction between the user and software running in the computer, the guider comprising:
a knowledgebase provided by an expert on the topic, and comprising an optionally nested set of selected subtopics of the topic, arranged in a decision tree of nodes connected by path portions with questions at branching nodes for output to the user wherein the user's input answer selects a path portion to another node;
an expert advice item at a node, wherein the item advises the user with information intended to assist the user in answering a question or in selecting an option when the user is at the node; and
a searching node wherein a search string, constructed according to the path that the user selected to reach the searching node, is submitted to a search engine, and links to resources returned by the search engine are output to the user, thereby researching the topic by performing a new search and outputting a new listing of resources that are expertly focused on the topic.
